(19) United States
(12) Patent Application Publication
(10) Pub. No.: US 2024/0083102 A1
(43) Pub. Date: Mar. 14, 2024

(54) Fuel Cell Liner Installation Device And Method Of Use

(71) Applicant: Colton Wilding, Ogden, UT (US)

(72) Inventor: Colton Wilding, Ogden, UT (US)

(21) Appl. No.: 17/944,842

(22) Filed: Sep. 14, 2022

(51) Int. Cl. B29C 63/28; B29C 63/00; B29C 63/22; B64D 47/00; H01M 8/2475

(52) U.S. Cl. CPC B29C 63/28; B29C 63/0073; B29C 63/22; B64D 47/00; H01M 8/2475; H01M 2250/20

(57) ABSTRACT

A fuel cell liner installation device for properly installing fuel cell liners in an aircraft includes a bladder, which is flexible. A connector attached to the bladder is selectively connectable to a source of pressurized gas. In a collapsed state, the bladder is insertable into a cavity in a hull of an aircraft. The cavity is defined by a plurality of stringers that is lined with a plurality of fuel cell liners. Upon inflation, the bladder is sized and shaped substantially complementarily to the cavity and exerts a force upon the fuel cell liners to maintain the fuel cell liners in position as adhesive, which is positioned between the fuel cell liners and the stringers, cures. The bladder then can be deflated and removed from the cavity, positioning a user to install a fuel cell in the cavity.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to liner installation devices and more particularly pertains to a new liner installation device for properly installing fuel cell liners in an aircraft. The present invention discloses a liner installation device that is used during installation of fuel cell liners in an aircraft. The liner installation device holds the fuel cell liners in position as they are glued to stringers.

### (2) Description of Related Art Including Information Disclosed Under 37 CFR 1.97 and 1.98

The prior art relates to liner installation devices, which may comprise bladders used to install liners within pipes. Related prior art comprises bladders for use in manufacturing of fuel tanks, insulated water heaters, tires, and other molded products. The prior art does not teach a liner installation device for use during installation of fuel cell liners in an aircraft.

### BRIEF SUMMARY OF THE INVENTION

An embodiment of the disclosure meets the needs presented above by generally comprising a bladder, which is flexible. A connector is attached to the bladder and is configured to selectively connect to a source of pressurized gas so that the bladder is in fluidic communication with the source of pressurized gas. The bladder is configured to be selectively inflated from a collapsed state to an expanded state. In the collapsed state, the bladder is insertable into a cavity in a hull of an aircraft. The cavity is defined by a plurality of stringers that is lined with a plurality of fuel cell liners. In the expanded state, the bladder is sized and shaped substantially complementarily to the cavity. The bladder is configured to be inflated to exert a force upon the fuel cell liners to maintain the fuel cell liners in position as adhesive, which is positioned between the fuel cell liners and the stringers, cures. The bladder is configured to be deflated and removed from the cavity, positioning a user to install a fuel cell in the cavity.

Another embodiment of the disclosure includes a method of utilizing the bladder to exert a force upon the fuel cell liners to maintain the fuel cell liners in position as adhesive, which is positioned between the fuel cell liners and the stringers, cures.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top isometric perspective view of a fuel cell liner installation device according to an embodiment of the disclosure.

FIG. 2 is a bottom isometric perspective view of an embodiment of the disclosure.

FIG. 3 is a top view of an embodiment of the disclosure.

FIG. 4 is a side view of an embodiment of the disclosure.

FIG. 5 is a cross-sectional view of an embodiment of the disclosure.

FIG. 6 is an isometric perspective view of an embodiment of the disclosure.

FIG. 7 is an in-use view of an embodiment of the disclosure.

FIG. 8 is an in-use view of an embodiment of the disclosure.

FIG. 9 is an in-use view of an embodiment of the disclosure.

FIG. 10 is a flow diagram for a method utilizing an embodiment of the disclosure.

### DETAILED DESCRIPTION OF THE INVENTION

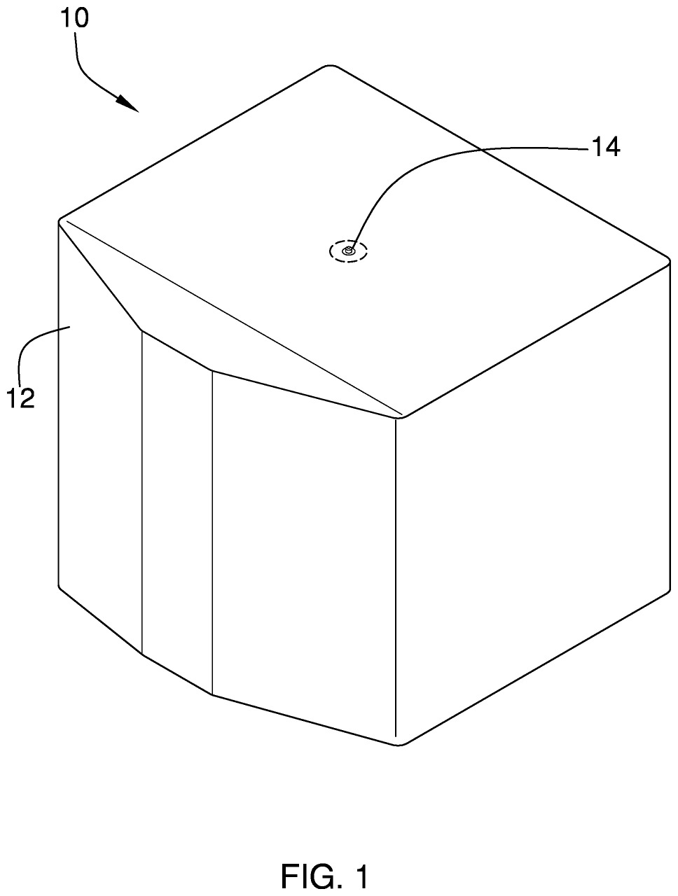

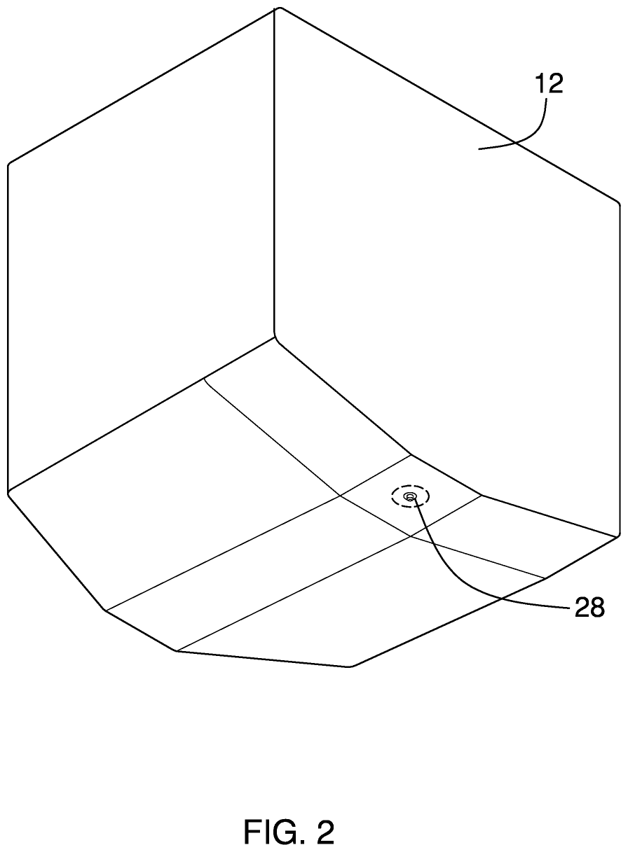

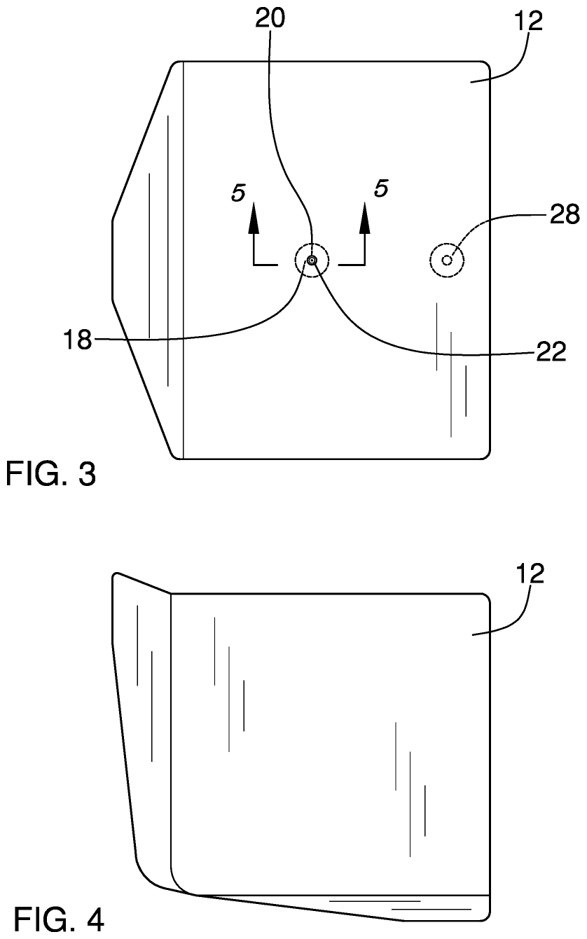

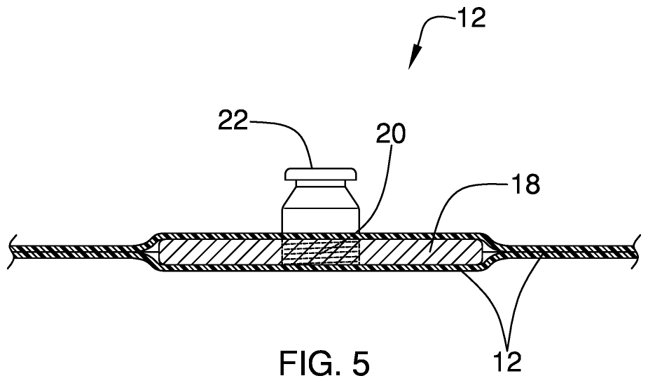

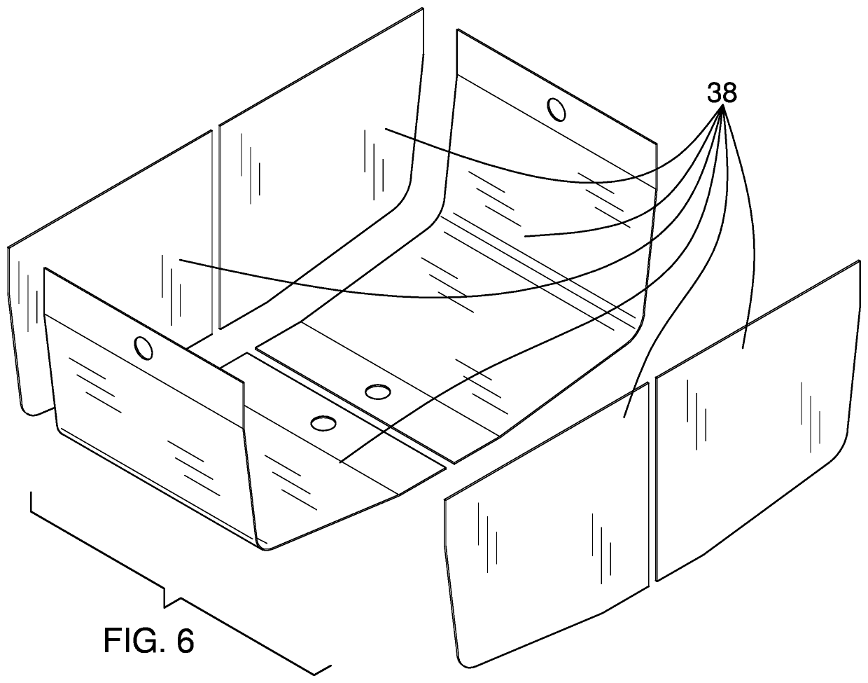

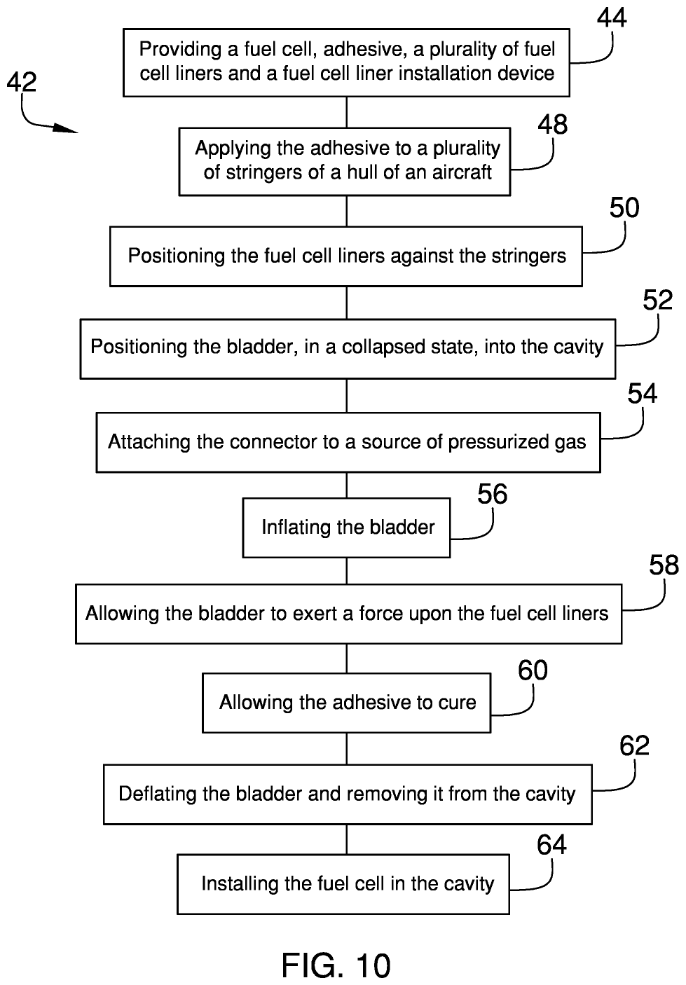

With reference now to the drawings, and in particular to FIGS. 1 through 10 thereof, a new liner installation device embodying the principles and concepts of an embodiment of the disclosure and generally designated by the reference numeral 10 will be described.

As best illustrated in FIGS. 1 through 10, the fuel cell liner installation device 10 generally comprises a bladder 12, which comprises polyvinylchloride, other vinyl polymers, isobutylene isoprene rubber, or the like, and thus is flexible. A connector 14 is attached to the bladder 12 and is configured to selectively connect to a source of pressurized gas 16 so that the bladder 12 is in fluidic communication with the source of pressurized gas 16, such as an air compressor, hand pump, or the like. The connector 14 comprises a plate 18 in which a hole 20 is positioned. A first hose coupler 22 is threadedly inserted into the hole 20, which is threaded. The first hose coupler 22 is configured to engage a second hose coupler 24, which is attached to an air hose 26 that extends from the source of pressurized gas 16.

The fuel cell liner installation device 10 also may comprise a relief valve 28, which is attached to the bladder 12 and configured to release gas upon a preset pressure, for example, 50 psi, being reached in the bladder 12. The relief valve 28 prevents the bladder 12 from becoming over pressurized. The present invention also anticipates a pressure regulator, which is positioned inline between the source of pressurized gas 16 and the bladder 12, to maintain a substantially constant pressure within the bladder 12, for example, 25 psi.

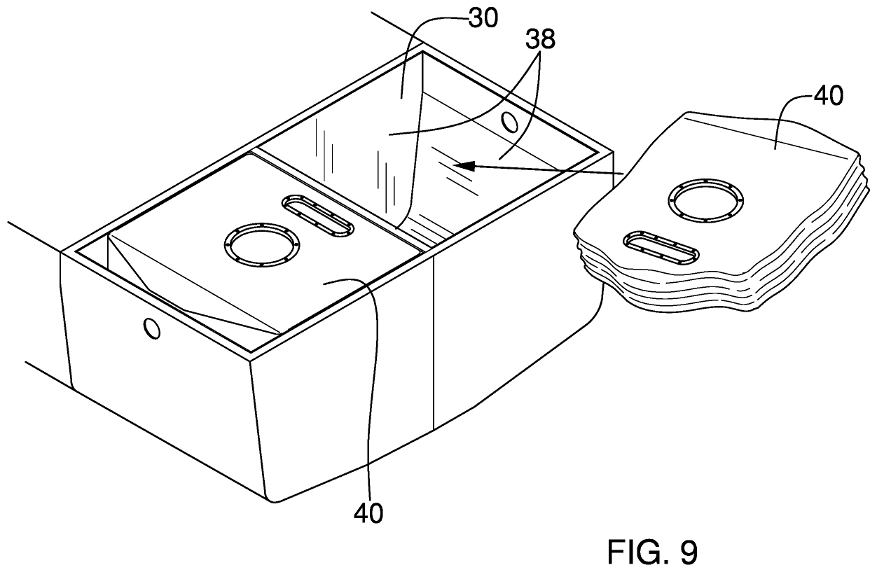

The bladder 12 is configured to be selectively inflated from a collapsed state to an expanded state, as shown in to the right and to the left in FIG. 8, respectively. In the collapsed state, the bladder 12 is insertable into a cavity 30 in a hull 32 of an aircraft 34. Examples of such aircraft 34 include, but are not limited to, Sikorsky UH-60 Black Hawk helicopters, Sikorsky SH-60 Seahawk helicopters, Bell Boeing V-22 Osprey tiltrotor aircraft, and the like. The cavity 30 is defined by a plurality of stringers 36 that is lined with a plurality of fuel cell liners 38. The fuel cell liners 38 are essential to proper and safe performance of a fuel cell 40 that is to be positioned in the cavity 30.

In the expanded state, the bladder 12 is sized and shaped substantially complementarily to the cavity 30. The bladder 12 is configured to be inflated to exert a force upon the fuel cell liners 38 to maintain the fuel cell liners 38 in position as adhesive, which is positioned between the fuel cell liners 38 and the stringers 36, cures. The bladder 12 is configured to be deflated and removed from the cavity 30, positioning a user to install the fuel cell 40 in the cavity 30.

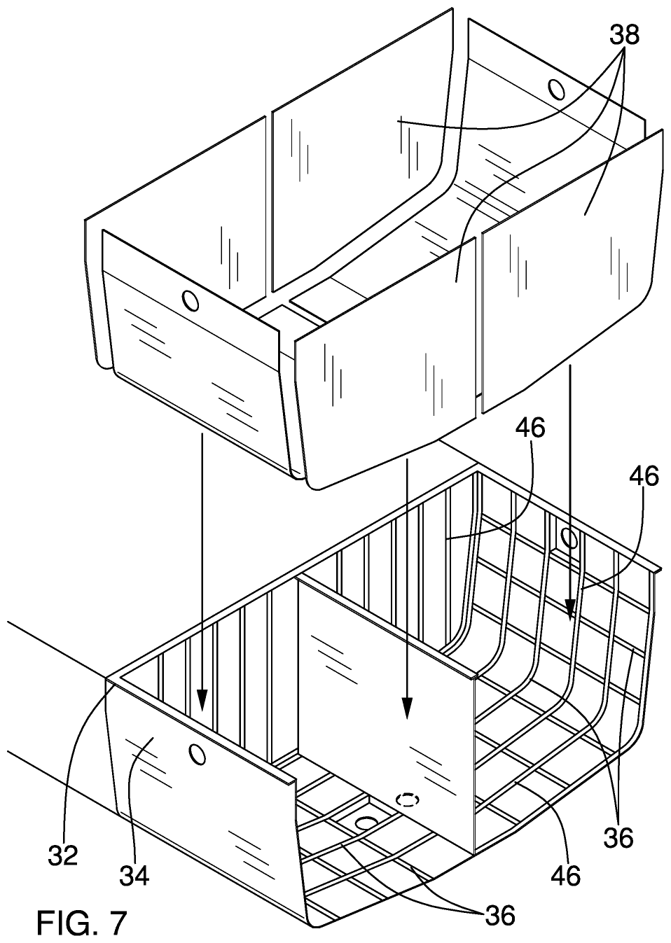

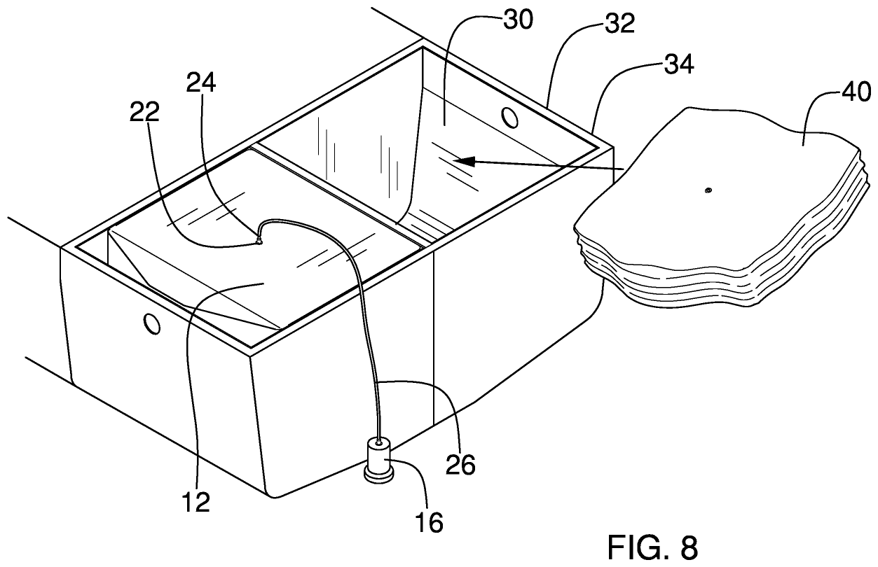

The fuel cell liner installation device 10 enables a method of installing fuel cell liners and a fuel cell 42, as shown in FIGS. 7-9. The method 42 comprises a provision step 44, which entails providing a fuel cell 40, adhesive 46, and a plurality of fuel cell liners 38, along with a fuel cell liner installation device 10 according to the specification above. An application step 48 of the method 42 entails applying the adhesive to a plurality of stringers 36 of a hull 32 of an aircraft 34. A first positioning step 50 entails positioning the fuel cell liners 38 against the stringers 36 to define a cavity 30. A second positioning step 52 entails positioning the bladder 12, in a collapsed state, into the cavity 30.

An attachment step 54 of the method 42 entails attaching the connector 14 to the source of pressurized gas 16 so that the bladder 12 is in fluidic communication with the source of pressurized gas 16. An inflation step 56 entails inflating the bladder 12 to an expanded state. The bladder 12 is sized and shaped substantially complementarily to the cavity 30. A pressure step 58 entails allowing the bladder 12 to exert a force upon the fuel cell liners 38 to maintain the fuel cell liners 38 in position. A curing step 60 entails allowing the adhesive to cure. A deflation step 62 entails deflating the bladder 12 and removing it from the cavity 30. An installation step 64 entails installing the fuel cell 40 in the cavity 30.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fuel cell liner installation device comprising:
a bladder, the bladder being flexible; and
a connector attached to the bladder and being configured for selectively connecting to a source of pressurized gas, such that the bladder is in fluidic communication with the source of pressurized gas, wherein the bladder is configured for being selectively inflated from a collapsed state, wherein the bladder is insertable into a cavity in a hull of an aircraft defined by a plurality of stringers lined with a plurality of fuel cell liners, and an expanded state, wherein the bladder is sized and shaped substantially complementarily to the cavity, wherein the bladder is configured for inflating for exerting a force upon the fuel cell liners for maintaining the fuel cell liners in position as adhesive positioned between the fuel cell liners and the stringers cures, wherein the bladder is configured for being deflated and removed from the cavity, positioning a user for installing a fuel cell in the cavity.

2. The fuel cell liner installation device of claim 1, wherein the bladder comprises polyvinylchloride.

3. The fuel cell liner installation device of claim 1, wherein the connector comprises:
a plate;
a hole positioned in the plate, the hole being threaded; and
a first hose coupler threadedly inserted into the hole, first hose coupler is configured for engaging a second hose coupler attached to an air hose extending from the source of pressurized gas.

4. The fuel cell liner installation device of claim 1, further including a relief valve attached to the bladder, wherein the relief valve is configured for releasing gas upon a preset pressure being reached in the bladder.

5. The fuel cell liner installation device of claim 1, further including:
the bladder comprising polyvinylchloride;
the connector comprising:
a plate,
a hole positioned in the plate, the hole being threaded, and
a first hose coupler threadedly inserted into the hole, first hose coupler is configured for engaging a second hose coupler attached to an air hose extending from the source of pressurized gas; and
a relief valve attached to the bladder, wherein the relief valve is configured for releasing gas upon a preset pressure being reached in the bladder.

7. A method of installing fuel cell liners and a fuel cell, the method comprising the steps of:
providing a fuel cell, adhesive, a plurality of fuel cell liners, and a fuel cell liner installation device comprising:
a bladder, the bladder being flexible, and
a connector attached to the bladder and being configured for selectively connecting to a source of pressurized gas;
applying the adhesive to a plurality of stringers of a hull of an aircraft;
positioning the fuel cell liners against the stringers defining a cavity;
positioning the bladder, in a collapsed state, into the cavity;
attaching the connector to the source of pressurized gas, such that the bladder is in fluidic communication with the source of pressurized gas;
inflating the bladder to an expanded state, wherein the bladder is sized and shaped substantially complementarily to the cavity;
allowing the bladder to exert a force upon the fuel cell liners for maintaining the fuel cell liners in position;
allowing the adhesive to cure;
deflating the bladder and removing it from the cavity; and
installing the fuel cell in the cavity.

8. The method of claim 7, wherein the bladder comprises polyvinylchloride.

9. The method claim 7, wherein the connector comprises:
a plate;
a hole positioned in the plate, the hole being threaded; and
a first hose coupler threadedly inserted into the hole, first hose coupler is configured for engaging a second hose coupler attached to an air hose extending from the source of pressurized gas.

10. The method of claim 7, further including a relief valve attached to the bladder, wherein the relief valve is configured for releasing gas upon a preset pressure being reached in the bladder.
